(19) United States
(12) Patent Application Publication
(10) Pub. No.: US 2015/0205820 A1
(43) Pub. Date: Jul. 23, 2015

(54) GEOGRAPHIC MNEMONICS

(71) Applicant: TollShare, Inc., Danville, CA (US)

(72) Inventors: Murali M. Karamchedu, Portland, OR (US); Ravi Asnani, Los Angeles, CA (US); Sanjay Nambiar, Los Angeles, CA (US)

(73) Assignee: TollShare, Inc., Danville, CA (US)

(21) Appl. No.: 14/161,573

(22) Filed: Jan. 22, 2014

(51) Int. Cl. G06F 17/30

(52) U.S. Cl. CPC G06F 17/30241; G06F 17/30864

(57) ABSTRACT

Apparatuses, methods and storage medium associated with geographic mnemonics are disclosed herein. In embodiments, an apparatus may include a registration module and a response module. The registration module may be configured to accept a registration of a geographic mnemonics, and store the geographic mnemonics. Acceptance of registration and storage of the geographic mnemonics may further comprise receipt of an address and/or meta data to be associated with the geographic mnemonics, and storage of the address and/or meta data as associated with the geographic mnemonics. The response module may be configured to respond to a query about the geographic mnemonics, with at least the associated address and/or meta data. Other embodiments may be described and/or claimed.

### TECHNICAL FIELD

The present disclosure relates to the field of data processing, in particular, to apparatuses, methods and storage medium associated with providing geographic mnemonics services.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in computing, networking and related technologies have led to proliferation in the availability of contents and/or information through the Internet. Today, users routinely use search services, such as Google®, Bing®, Yahoo®, and so forth, to locate information. Generally speaking, user searches or questions can be broadly classified as “what,” “when,” “how,” or “where” questions. For examples, “what are the movies being shown in a local cinema complex,” “when is kick off for a football game,” “how do you make pop corns in microwave,” or “where is the magnificent mile?” Today, search services would typically make no distinction between the different types of questions, and employ the same approach to providing answers to these questioning, by maintaining a collection of indices indexing the contents/information available on Internet. The indices are keywords based, that is based on the presence of keywords in the content and/or the metadata associated with content, such as non-textual audio/video content. For example, an index would be generated and stored to keep track that a web page with the keywords “magnificent mile” may be potentially relevant to user searching for information with search criteria including the keyword “magnificent mile,” and/or other related words, such as “Chicago.” In response to a search query, the search service will utilize the keyword based indices or a subset thereof to generate and return an answer set with locators to potential relevant contents to the search query. Certain ranking and/or relevance analysis algorithm may be applied/used to filter and/or order the potential relevant contents/information included in the answer set.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an arrangement for providing geographic mnemonics service, in accordance with various embodiments.

FIG. 2 illustrates an example organization of the geographic mnemonics and their associated data, in accordance with various embodiments.

FIG. 3 illustrates an example process for providing geographic mnemonics services, in accordance with various embodiments.

FIG. 4 illustrates an example process for using geographic mnemonics service by other online services, in accordance with various embodiments.

FIG. 5 illustrates an example organization of the geographic mnemonics and the associated data, in accordance with various embodiments.

FIG. 6 illustrates an example storage and access of the geographic mnemonics and associated data, in accordance with various embodiments.

FIG. 7 illustrates an example computing environment suitable for practicing the disclosure, in accordance with various embodiments.

FIG. 8 illustrates an example storage medium with instructions configured to enable an apparatus to practice the processes of the present disclosure, in accordance with various embodiments.

### DETAILED DESCRIPTION

Apparatuses, methods and storage medium associated with geographic mnemonics are disclosed herein. In embodiments, an apparatus may include a registration module and a response module. The registration module may be configured to accept a registration of a geographic mnemonics, e.g., “&ravi_home,” and store the geographic mnemonics. Acceptance of registration and storage of the geographic mnemonics may further comprise receipt of an address to be associated with the geographic mnemonics, e.g., “12345 Hidden Canyon Rd., Palm Springs, Calif.,” and storage of the address as associated with the geographic mnemonics. The response module may be configured to respond to a query about the geographic mnemonics, with at least the associated address.

In embodiments, acceptance of registration and storage of the geographic mnemonics may further comprise receipt of meta data to be associated with the geographic mnemonics, e.g., “a direction to reach the address from Palm Desert,” and storage of the meta data as associated with the geographic mnemonics. The response module may be configured to respond to a query about the geographic mnemonics, further providing some or all of the associated meta data. Accordingly, user experience for locating information associated with a location or an area may be enhanced.

In embodiments, the registered/stored geographic mnemonics and their associated information may be queried and used by application services, such as search engine, social networking services, message services, Internet portal services, e-commerce services or email services, to enhance the respective services provided.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

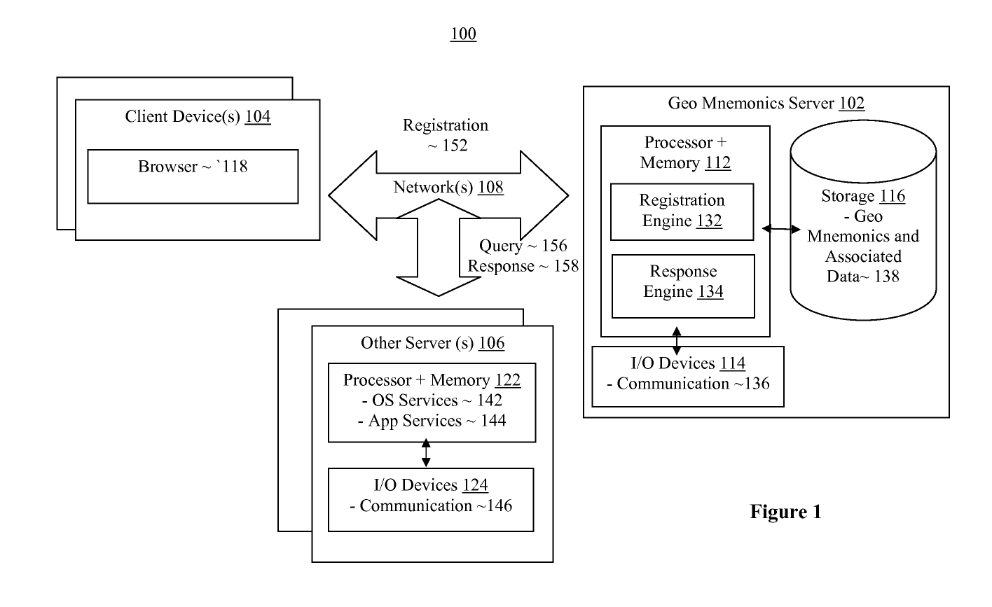

Referring now FIG. 1, wherein an arrangement for providing geographic mnemonics services, in accordance with various embodiments, is illustrated. As shown, in embodiments, arrangement 100 may include server 102 configured to offer geographic mnemonic services for client devices 104 and servers 106 of other online services. Geographic mnemonics server 102, client devices 104, and server 106 of other online services may be coupled to one another via network 108, as shown. In embodiments, server 102 may include processor and memory arrangement 112, input/output device 114, and storage 116, coupled with each other as shown. Processor and memory arrangement 112 may be configured to host registration engine 132, and response engine 134. In embodiments, registration engine 132 may be configured to accept registration of geographic mnemonics and their associated addresses from client devices 102, and store the registered geographic mnemonics and their associated addresses in storage 116 for subsequent provision to client devices 104 and/or servers 106 of other online services, in facilitating providing information associated with a location or an area. In embodiments, registration engine 132 may be further configured to accept meta data associated with the geographic mnemonics, from client devices 102, and store the associated meta data of the geographic mnemonics in storage 116 for subsequent provision to client devices 104 and/or servers 106 of other online services. Response engine 134 may be configured to provide the appropriate registered geographic mnemonics, associated addresses and/or met data, in response to subsequent query from client devices 104 and/or servers 106 of other online services.

In embodiments, the format of a geographic mnemonic may be defined by the geographic mnemonic service. In embodiments, the geographic mnemonic service may define a geographic mnemonic to have the format of one or more special characters, followed by any number of alphanumeric and special characters. For example, the geographic mnemonic service may define a geographic mnemonic to have the format of having the special character “&” as the lead off character, followed by one or more alphanumeric and special characters, such as “&Ravi_home,” or “&Schwabe_Seattle.” As another example, the geographic mnemonic service may define a geographic mnemonic to have the format of having the special characters “#&” as the lead off characters, followed by one or more alphanumeric and special characters, such as “#&Ravi_home,” or “#&Schwabe_Seattle.” These examples are just illustrative, and not meant to be limiting on the present disclosure.

In embodiments, in the course of storing geographic mnemonics, their associated addresses and meta data 138 into storage 116, registration engine 112 may further resolve the geographic mnemonics, based on its associated address, to a pair of geographic coordinates or geographic coordinate ranges, e.g., a pair of geodetic latitude and longitude coordinates, or a pair of geodetic latitude and longitude ranges. For example, the City and County of San Francisco may register the geographic mnemonics “&Coit_Tower,” to facilitate provision of various information associated with the landmark Coit Tower under the present disclosure. The associated address of “&Coit_Tower,” is “1 Telegraph Hill, Blvd, San Francisco, Calif.” In the course of storing “&Coit_Tower” as the registered geographic mnemonics, “1 Telegraph Hill, Blvd, San Francisco, Calif.” as the associated address, and so forth, registration engine 112 may resolve the address of “1 Telegraph Hill, Blvd, San Francisco, Calif.” of “&Coit_Tower” to the geodetic latitude and longitude coordinate pair of {37.8025° N, 122.4058° W}, and store also the geographic coordinates. As another example, the law firm Schwabe, Williamson & Wyatt may register the geographic mnemonics “&SWW_Seattle,” to facilitate provision of various information associated with the Seattle Office. The associated address of “&SWW_Seattle,” is “1420 5^{th} Ave., Suite 3400, Seattle, Wash.” In the course of storing “&SWW_Seattle” as the registered geographic mnemonics, “1420 5^{th} Ave., Suite 3400, Seattle, Wash.” as the associated address, and so forth, registration engine 112 may resolve the address of “1420 5^{th} Ave., Suite 3400, Seattle, Wash.” of “&SWW_Seattle” to a pair of geodetic latitude and longitude coordinate, and store also the geographic coordinates. Further, in embodiments, registration engine 112 may organize the storage of the geographic mnemonics, their associated addresses, and meta data, based at least in part on the geographic coordinates to facilitate subsequent processing and retrieval.

While the above example illustrated the resolution to geodetic coordinates that are valued in accordance with a mathematical defined reference ellipsoid that approximates the Earth, the present disclosure is not so limited. Other geographic coordinates with other geographic reference systems may also be used, including but are not limited to, e.g., geocentric coordinates that are valued in accordance with a X-Y-Z reference centered at Earth's center, or spherical coordinates that are valued based on the radial distances from Earth's center, along with polar angles measured from the zenith directions of the positions, and azimuth angles of the positions based on orthogonal projections on corresponding reference planes that pass through Earth's center and orthogonal to the zenith directions.

While for ease of understanding, registration engine 132 and response engine 134 are being illustrated as being operated by processors of processor and memory arrangement 112, in embodiments, registration engine 132 and response engine 134 may be implemented in any combination of hardware and/or software. In embodiments, the combination of hardware and/or software may include processor(s), memory and executable instructions implementing the functions described herein. In embodiments, in lieu of being two separate engines, registration engine 132 and response engine 134 may share some common functions and/or resources. For example, registration engine 132 and response engine 134 may share common communication functions and components for communicating with client devices 104 and servers 106 of other online services. As a further example, registration engine 132 and response engine 134 may share processor and/or memory resources. In embodiments, some functions of registration engine 132 and response engine 134, or vice versa, or be combined.

Processor and memory arrangement 112, in addition to registration engine 132 and response engine 134, may further host execution of various operating system (OS) services (not shown). The OS services may include any one of a number of OS services known in the art, including but not limited to memory management, task management, and so forth. I/O devices 114 may include one or more communication interfaces 128 configured to facilitate communication with client devices 104, and servers 106 of other online services. Communication interfaces 128 may be any one of a number of communication components/interfaces known in the art, including but not limited to wired or wireless communication components for personal, local and/or wide area network communications. Storage 116 may be implemented using any magnetic, optical, and/or solid state non-volatile storage. The magnetic, optical, and/or solid state non-volatile storage may be disposed on one platform, or coupled/networked. In embodiments, storage 116 may also include volatile and/or non-volatile caches. Accordingly, except for the teachings of the present disclosure incorporated therein, server 102 is intended to represent a broad of single or multi-processor servers known in the art. In embodiments, server 102 may include one or more clusters computing servers, which may be coupled with one another, via one or more local or wide area networks (not shown).

Still referring to FIG. 1, client device 104 may include browser 118 configured to access the geographic mnemonics service offered by server 102, including interactions with registration engine 132 to register one or more geographic mnemonics, including their associated addresses and meta data, and/or interactions with response engine 134 to query and retrieve geographic mnemonics and/or associated data. Thus, client device 104, except for its usage and consumption of the geographic mnemonics service, represents a broad range of client devices known in the art, including but not limited to personal digital assistants (PDA), smartphones, computing tablets, ultrabook, laptop computers, desktop computers, set-top box, media players, game consoles, in-vehicle/portable navigation/infotainment systems, and so forth.

Similar to server 102, each of servers 106 may include processor and memory arrangement 122, and I/O devices 124 coupled to with each other as shown. Processor and memory arrangement 122 may host OS Services 142 and application services 144. While I/O devices 124 may include one or more communication interfaces 146. Similar to processor and memory arrangement 112, processor and memory arrangement 122 may be any one of a wide range of such elements known in the art. Likewise, similar to I/O devices 114 and communication interfaces 136, I/O devices 124 and communication interfaces 146 may be any one of a wide range of such elements known in the art. As described earlier, OS Services 142 may include a wide range of OS services, including but not limited to memory management, task management, and so forth. Application services 144, except for their usage of geographic mnemonics services, may likewise be any one of a number of online services known it art. Examples of such services may include, but are not limited to, online search services, social networking services, messaging services, Internet portal service, e-commerce service, and email service to be described in more detail below.

Networks 108 may be any combinations of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the servers' end, networks 108 may include one or more local area networks with gateways and firewalls, through which servers 102 and 106 go through to communicate with client devices 104 and each other. Similarly, at the client device end, networks 108 may include base stations and/or access points, through which client devices 104 communicate with servers 102 and 106. In between the various ends may be any number of network routers, switches and other networking equipment of the like. However, for ease of understanding, these gateways, firewalls, routers, switches, base stations, access points and the like are not shown.

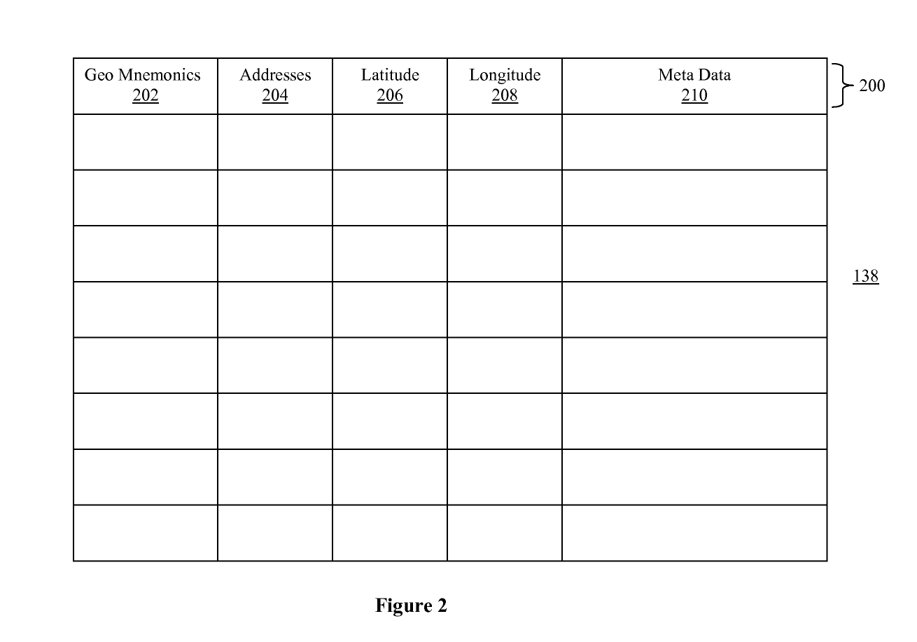

Referring now to FIG. 2, wherein an example organization of geographic mnemonics and their associated data, in accordance with various embodiments, is shown. As illustrated, in embodiments, each geographic mnemonics record 200 may include the registered geographic mnemonics 202, its associated address 204, and meta data 210. Further, for embodiments where registration engine 132 resolves the address to a set of geographic coordinates of a location on Earth's surface, e.g., a pair of latitude and longitude coordinates, record 200 may further include the geographic coordinates 206 and 208.

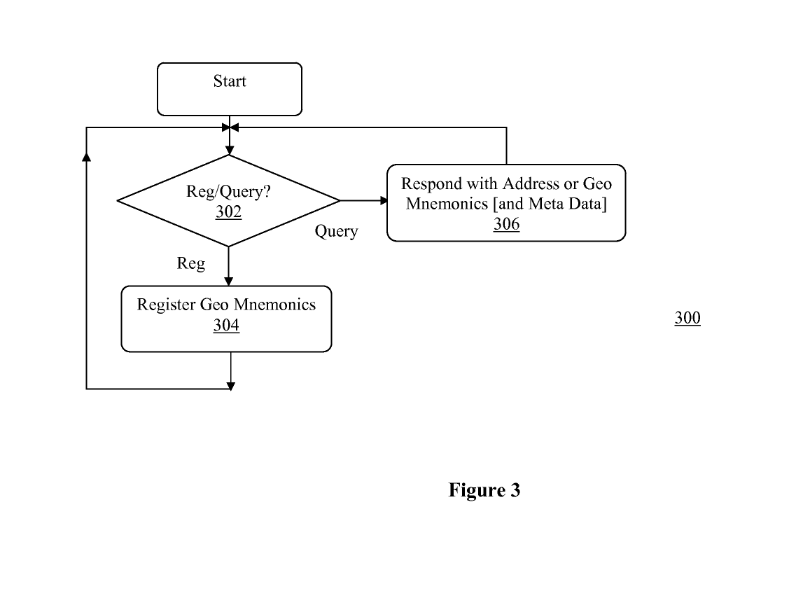

Referring now to FIG. 3, wherein an example process for providing geographic mnemonics services, in accordance with various embodiments, is illustrated. As shown, process 300 may include operations at blocks 302-306. The operations may be performed, e.g., by the earlier described registration engine 132 and response engine 134 of geographic mnemonics server 102.

At block 302, a request for service may be received. In response, a determination may be made on whether the request is for registration of a geographic mnemonics, for retrieving data associated to a geographic mnemonics or for retrieving geographic mnemonics at a location or within an area. An example request to register a geographic mnemonics may be a request to register, e.g., “&Coit_Tower” as geographic mnemonics. An example request for data associated to a geographic mnemonics may comprise a query for the address and/or meta data associated with a geographic mnemonics. An example request for geographic mnemonics may comprise a query for geographic mnemonics at an address, e.g., “1 Telegraph Hill, Blvd, San Francisco, Calif.”,” or geographic mnemonics within an area, .e.g., “North Beach of San Francisco.” Note that one or more geographic mnemonics, e.g., geographic mnemonics registered by different family members of a family, such as “&AdamSmith_Home,” and “AnnaSmith_Home,” may resolve to the same address.

On determining that the request is for registration of a geographic mnemonics, process 300 may proceed to block 304. At block 304, the geographic mnemonics being registered may be accepted and stored, e.g., in storage 116. In embodiments, registration engine 132 may be configured to ensure each registered geographic mnemonics is unique, and deny registrations for geographic mnemonics that have already been registered. Additionally, acceptance and storage of the geographic mnemonics may include acceptance and storage of an address to be associated with the geographic mnemonics. For example, on accepting and storing the example geographic mnemonics of “&Coit_Tower,” the example address “1 Telegraph Hill, Blvd, San Francisco, Calif.,” may be accepted and stored as the address to be associated with the example geographic mnemonics of “&Coit_Tower.” The example geographic mnemonics is merely intended to be illustrative and is not to be read as limiting on the present disclosure. It is anticipated that a wide range of geographic mnemonics, including e.g., private geographic mnemonics, such as “&Ravi_home,” may be accepted and stored.

Further, in embodiments, concurrent with the initial registration or subsequent to the initial registration, acceptance and storage of the geographic mnemonics may further include acceptance and storage of meta data to be associated with the geographic mnemonics. For example, for the example geographic mnemonics of “&Coit_Tower,” meta data comprising a direction to Coit Tower, seasonal operating hours and so forth, may be accepted and stored. The example meta data are merely intended to be illustrative and are not to be read as limiting on the present disclosure. It is anticipated that a wide range of meta data may be accepted and stored for each geographic mnemonics. Thereafter, process 300 may return to block 302, and continue therefrom as earlier described.

Back at block 302, if the result of the determination is a request for data associated to a geographic mnemonics or geographic mnemonics at a location or within an area, process 300 may proceed to block 306. At block 306, in response to a request for data associated to geographic mnemonics, the response may include the associated address. Additionally, if the request also requested for meta data or particular type of meta, the response may further include some or all the meta data matching the request criteria. Thereafter, process 300 may return to block 302, and continue therefrom as earlier described.

Referring to FIG. 1 again, as described earlier, it is anticipated, in addition to client device 104, servers 106 of various online services may also utilize the geographic mnemonics services of geographic mnemonics server 102 to enhance the services they provide. For example, an online search may support search for geographic mnemonics and/or information related to geographic mnemonics, thereby enhancing the user experience for searching for information related to a location or an area. On receipt of a search query, the search engine may determine whether the search query includes a geographic mnemonics or a request for geographic mnemonics at a location or within an area. On determination that the search query include a geographic mnemonics, an area expressed in term of a geographic mnemonics (e.g., &Coit_Tower and vicinity within 5 miles), or a request for geographic mnemonics at a location or within an area, instead of treating these search criteria as keywords, the search engine may query geographic mnemonics server 102 for the information instead. Further, the search engine may provide search services, additionally based on information associated with geographic mnemonics obtained from geographic mnemonics server 102.

In another non-limiting example, the online service may be a social networking services configured to facilitate client devices 104 to socially network with each other. In embodiments, the social networking services may extend its support to include supports that allow geographic mnemonics as “users.” As a result, owner user of geographic mnemonics may post contents against the geographic mnemonics. Other users may elect to be associated with the geographic mnemonics (“friend” the geographic mnemonics). These users may then see the posted contents for the geographic mnemonics, and/or receive notification from the social networking service about new contents being posted for the geographic mnemonics. Further, the social networking service may provide social networking, additionally based on information associated with geographic mnemonics obtained from geographic mnemonics server 102.

In still another non-limiting example, the online service may be a messaging service configured to facilitate client devices 102 to message each other, including e.g., but not limited to, short messages. In embodiments, the messaging service may extend its support to include supports that allow for recognition of geographic mnemonics. In other words, the messaging service may recognize a term starting off with the special characters “#&,” and followed by any number alphanumeric or special characters, as a geographic mnemonics, differ from other tagged words. As a result, a geographic mnemonics may become a tagged keyword or topic, enabling messages related the geographic mnemonics to be easily recovered. Further, the messaging service may facilitate messaging, additionally based on information associated with geographic mnemonics obtained from geographic mnemonics server 102.

In still another non-limiting example, the online service may be an Internet portal service, an e-commerce service, or an email service configured to respectively provide Internet portal, e-commerce, or email service to client devices 102. In embodiments, the Internet portal, e-commerce, or email service may extend its support to include supports for inclusion of geographic mnemonics in the Internet portal, e-commerce, and email service provided. In other words, the Internet portal, e-commerce, or email service may recognize geographic mnemonics in its provision of Internet portal, e-commerce, or email service, and facilitate resolution of geographic mnemonics with geographic mnemonics server 102. Further, the Internet portal, e-commerce, and email service may provide Internet portal, e-commerce, and email services, additionally based on information associated with geographic mnemonics obtained from geographic mnemonics server 102.

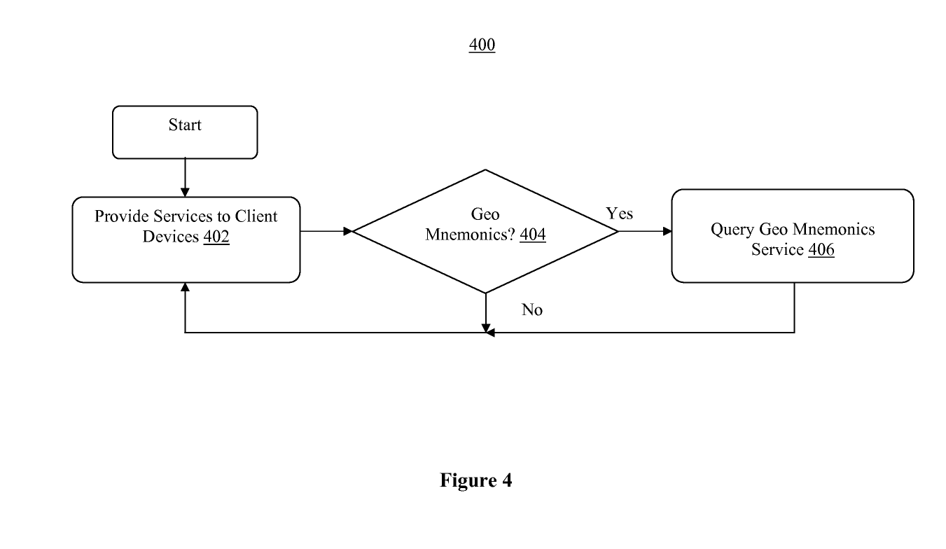

Referring now FIG. 4, wherein an example process for online services to utilize the geographic mnemonics service, in accordance with various embodiments, is illustrated. As shown, process 400 may include operations at blocks 402-406. The operations may be performed e.g., by application services 144 of FIG. 1 of various online services. As shown, process 400 may start at block 402. At block 402, an online service may provide its online services to its users. From block 402, process 400 may proceed to block 404. At block 404, a determination may be made on whether a service requested involves geographic mnemonics, and whether assistance from geographic mnemonics server 102 is needed. On determination that the service requested involves geographic mnemonics, and assistance from geographic mnemonics server 102 is needed, process 400 may proceed to block 406. At block 406, the online service may query geographic mnemonics server 102 for address and/or meta data of a geographic mnemonics, or for geographic mnemonics at a location or within an area.

From block 406, process 400 may return to block 402, and continue there from as earlier described, except the services may now be provided leveraging on the information obtained from geographic mnemonic server 102. For example, application service 144 (search, social networking, messaging etc.), through a geographic mnemonics associated with an area, e.g. San Francisco, may be able to obtain information associated with the geographic mnemonics associated with San Francisco, as well as information associated with geographic mnemonics within the area, such as information associated with the geographic mnemonics associated with Coit Tower, Lombard Street and so forth, and provide its service leveraging on these information obtained from geographic mnemonics server 102. Similarly at block 404, on determination that the service requested does not involve geographic mnemonics or not need the assistance of geographic mnemonics server 102, process 400 may return to block 402, and continue there from as earlier described.

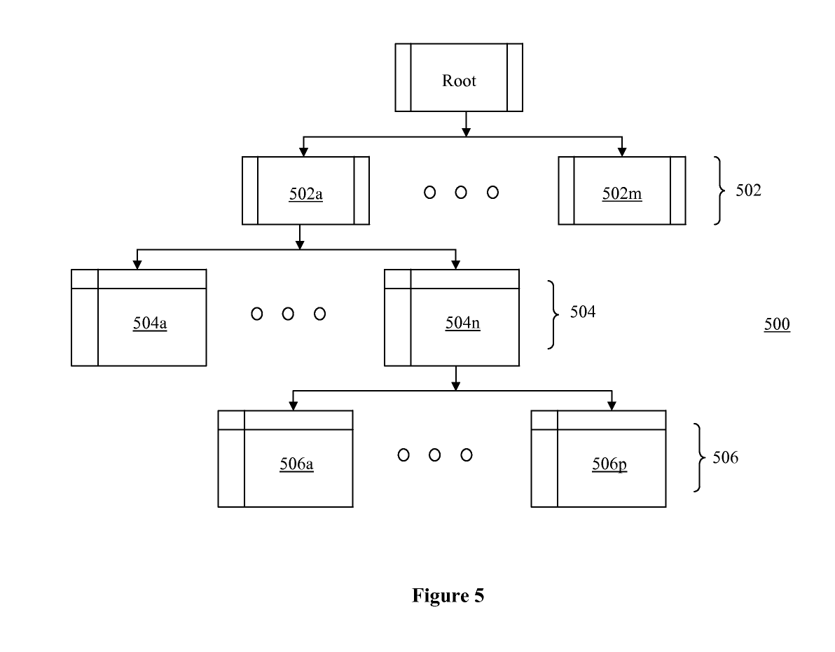

Referring now briefly back to FIG. 2, in embodiments, the geographic mnemonics and their associated data 138 may be stored in storage 120 in any one of a number of data organizations or structures, to facilitate efficient traversal for identification of potential relevant geographic mnemonics and their associated data 138. FIG. 5 illustrates an example organization of the geographic mnemonics and their associated data 138, in accordance with various embodiments. Example organization 500 may be a hierarchical organization/structure having a number of organization levels, including one or more intermediate or node levels 502-504 and the lowest or leaf level 506. In embodiments, geographic mnemonics and their associated data having geographic coordinates of various specific locations may be stored in the lowest or leaf level 506, such as 506a . . . 506p. Further, geographic mnemonics and their associated data having geographic coordinate ranges defining areas and/or regions of various sizes may be stored in the one or more intermediate levels 502, 504, and so forth, such as 502a . . . 502m and 504a . . . 504n.

For example, in one embodiment, the lowest level 506 may store the geographic mnemonics and their associated data having geographic coordinates of specific locations, e.g. “1 Telegraph Hill Blvd, San Francisco, Calif.” A next immediate intermediate level, e.g., level 504, may store geographic mnemonics and their associated data having geographic coordinates of a wider area, such as a City like San Francisco, Los Angeles, and so forth. Further, another intermediate level (not shown) above intermediate level 504 may store may store geographic mnemonics and their associated data having geographic coordinate ranges defining States, such as California, Oregon, and so forth. Still further, yet another intermediate level, such as intermediate level 502 may store geographic mnemonics and their associated data having geographic coordinate ranges representing Countries, such as United States, Canada, and so forth.

The above example is not intended to be limiting on the present disclosure. The present disclosure may be practiced with any data organization or structure, depending on the application. In the case of hierarchical organization, the hierarchical organization may have any number of levels, with the nodes of the intermediate levels storing geographic coordinate ranges defining any geographic, political, cultural, social, and/or economic organizations.

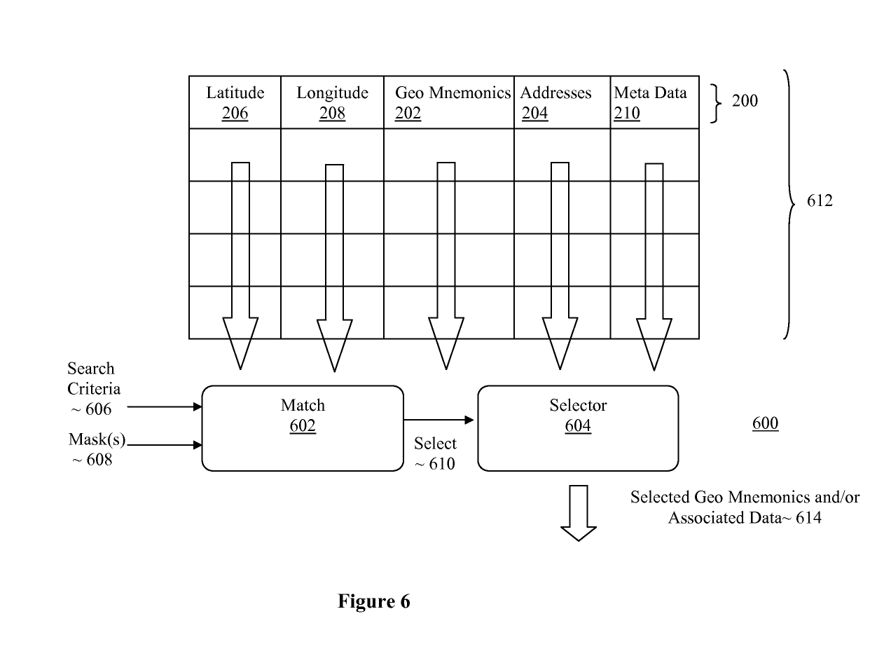

FIG. 6 illustrates an example storage and access of the geographic mnemonics and their associated data, in accordance with various embodiments. In applications/embodiments, or in a particular instance in time in the use of an application, one or more operational subsets of the geographic mnemonics and their associated data 138 may be cached by one or more client devices 104 or servers 102 and 106. For example, a portable or handheld client device 104 may be provided with the subset of geographic mnemonics and their associated data of one or more areas, regions, if the application or an instant use of the application is known to be confined in the one or more areas/regions. The example subset is not meant to be limiting, other subset derivations of the larger set of geographic mnemonics and associated data are also possible and anticipated.

For the example applications/embodiments, the subset of geographic mnemonics and their related may be stored in a content addressable memory (CAM) 600 on the particular client device 104 or one or servers 102/106. CAM 600, in addition to storage locations 612 for storing each 200 of the subset of geographic mnemonics and their associated data 138, may be configured with match circuitry 602 and selector 604, coupled with each other as shown. An application or service on access of CAM 600 may also provide geographic mnemonics or address based search criteria 606, optionally accompanied with one or more masks 608.

On access, storage locations may output geographic mnemonics and/or their geographic coordinates to match circuitry 602 and the associated data to selector 604. In embodiments, geographic mnemonics may be provided to match circuitry 602 and/or selector 604 depending on application (e.g., with the additional employment of a switch (not shown). Match circuitry 602 may output one or more select signals 610 to selector 604, based on geographic coordinates 206-208, search criteria 606, and mask(s) 608 (if provided). Selector 604 may then select and output geographic mnemonics 202, addresses 208 and/or meta data 210, based on select signal(s) 610. Accordingly, the ability to select associated geographic mnemonics and associated data may be provided.

For example, consider the geodetic coordinates of San Francisco and San Jose, which in decimal form may be {37.757687,−122.415161} and {37.335224,−121.898804}, respectively. In hexadecimal, these values are {24022F7,−74BE839} and {239B0B8,−7440734}, respectively. Thus, with the geographic coordinates stored in binary form, with appropriate masks, geographic mnemonics resolved to geographic coordinates of San Francisco and San Jose may be selected for a search query searching for geographic mnemonics and/or associated data for the Bay Area.

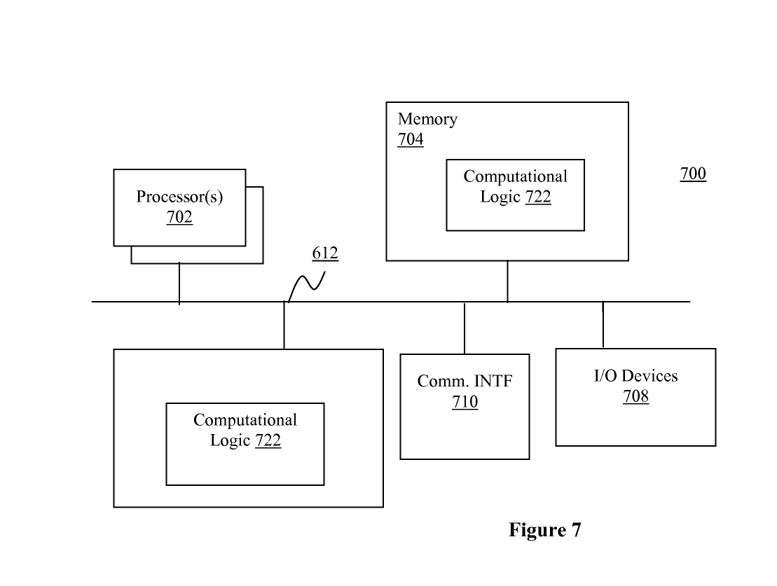

Referring now to FIG. 7, wherein an example computer suitable for use as either client device 104 or server 102/106 of FIG. 1, in accordance with various embodiments, is illustrated. As shown, computer 700 may include one or more processors or processor cores 702, and system memory 704. For the purpose of this application, including the claims, the terms “processor” and “processor cores” may be considered synonymous, unless the context clearly requires otherwise. System memory 704 may include volatile and or non-volatile memory, including CAM. Additionally, computer 700 may include mass storage devices 706 (such as diskette, hard drive, compact disc read only memory (CD-ROM) and so forth), input/output devices 708 (such as display, keyboard, cursor control and so forth) and communication interfaces 710 (such as network interface cards, modems and so forth). The elements may be coupled to each other via system bus 712, which may represent one or more buses. In the case of multiple buses, they may be bridged by one or more bus bridges (not shown).

Each of these elements may perform its conventional functions known in the art. In particular, system memory 704 and mass storage devices 706 may be employed to store a working copy and a permanent copy of the programming instructions implementing the various operations earlier described, e.g., the operations associated with registration engine 132, response engine 134, an/or application services 144 collectively denoted as computational logic 722. Computational logic 722 may be implemented with assembler instructions supported by processor(s) 702 or high-level languages, such as, for example, C, that can be compiled into such instructions.

The permanent copy of the programming instructions may be placed into permanent storage devices 706 in the factory, or in the field, through, for example, a distribution medium (not shown), such as a compact disc (CD), or through communication interface 710 (from a distribution server (not shown)). That is, one or more distribution media having an implementation of computational logic 722 may be employed to distribute computational logic 722 and program various computing devices.

The number, capability and/or capacity of these elements 710-712 may vary, depending on whether computer 700 is used as a client device 104 or server 102/106. When use as client device 104, whether client device 104 is a stationary or mobile device, like a smartphone, in-vehicle/portable navigation/infotainment systems, computing tablet, ultrabook or laptop, with general or specific applications. The constitutions of these elements are otherwise known, and accordingly will not be further described.

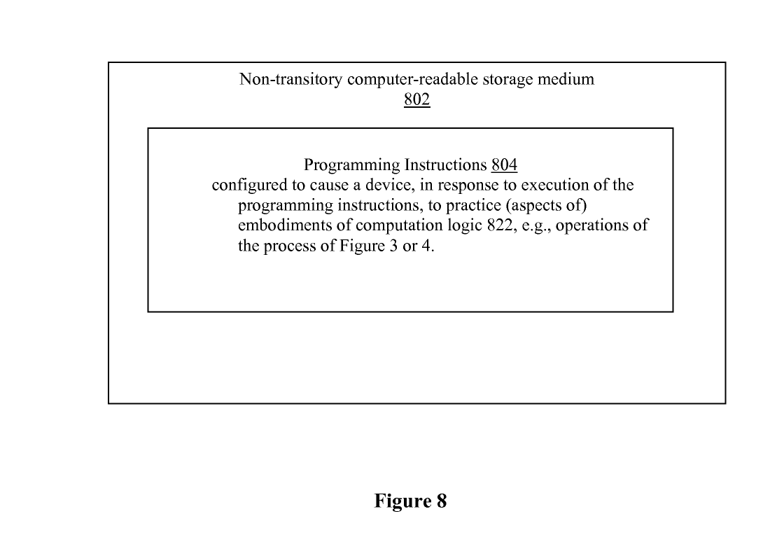

FIG. 8 illustrates an example non-transitory computer-readable storage medium having instructions configured to practice all or selected ones of the operations associated with registration engine 132, response engine 134, an/or application services 144, earlier described; in accordance with various embodiments. As illustrated, non-transitory computer-readable storage medium 802 may include a number of programming instructions 804. Programming instructions 804 may be configured to enable a device, e.g., computer 400, in response to execution of the programming instructions, to perform various ones of the earlier described operations, e.g., various operations of process 300 of FIG. 3 or process 400 of FIG. 4. In alternate embodiments, programming instructions 804 may be disposed on multiple non-transitory computer-readable storage media 802 instead.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the examples.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus for providing information about a location or area, comprising:
one or more processors;
one or more storage devices coupled with the one or more processors;
one or more communication interfaces coupled with the one or more processors;
a registration module configured to be operated by the one or more processors to accept a registration of a geographic mnemonics, via the one or more communication interfaces, and store the geographic mnemonics in the one or more storage devices, wherein acceptance of registration and storage of the geographic mnemonics further comprises receipt of an address to be associated with the geographic mnemonics, and storage of the address as associated with the geographic mnemonics; and
a response module configured to be operated by the one or more processors to respond to a query about the geographic mnemonics, with at least the associated address.

2. The apparatus of claim 1, wherein the geographic mnemonics comprises a special character followed by a plurality of alphanumeric or special characters.

3. The apparatus of claim 1, wherein acceptance of registration and storage of the geographic mnemonics further comprises receipt of meta data to be associated with the geographic mnemonics, and storage of the meta data associated with the geographic mnemonics; and wherein the response module is further configured to selectively respond to the query about the geographic mnemonics with some or all of the meta data.

4. The apparatus of claim 3, wherein the meta data comprises a direction to the address.

5. The apparatus of claim 1, wherein the registration module is further configured to resolve the address to a pair of geographic coordinates, and store the pair of geographic coordinates as associated with the geographic mnemonics.

6. The apparatus of claim 5, wherein the pair of geographic coordinates comprises a pair of longitudinal and latitude coordinates.

7. The apparatus of claim 5, wherein the response module is further configured to respond to a query about geographic mnemonics at a location or within an area, received through the one or more communication interfaces, with one or more geographic mnemonics at the location or within the area.

8. The apparatus of claim 7, wherein the response module is configured to translate the location or area to a pair or a range of geographic coordinates, and search the one or more storage devices, to identify the geographic mnemonics at the location or within the area, based on a result of the translation.

9. The apparatus of claim 1, wherein the query about the geographic mnemonics is received from a client device, via the one or more communication interfaces; wherein the client device is configured with a browser; and wherein the response module is configured to support interaction with the response module through the browser.

10. The apparatus of claim 1, wherein the query about the geographic mnemonics is received from a selected one of a search engine, a social network or a messaging service; wherein the search engine is configured to allow searches for geographic mnemonics or information associated with geographic mnemonics; wherein the social network includes supports for the geographic mnemonics as users, and supports for other users to be associated with or interact with the geographic mnemonics; wherein the messaging service include supports for geographic mnemonics, and supports for performing message searches based on geographic mnemonics; and wherein the response module is configured to support interaction with the search engine, the social network or the messaging service.

11. At least one computer-readable non-transitory storage medium comprising a plurality of instructions configured to cause a computer system, in response to execution of the instructions by the computer system, to respond to a query about a registered geographic mnemonics, including an address or meta data associated with the registered geographic mnemonics or an address or meta data associated with another registered geographic mnemonics within an area of the registered geographic mnemonics.

12. The storage medium of claim 11, wherein the geographic mnemonics comprises a special character followed by a plurality of alphanumeric or special characters.

13. The storage medium of claim 11, wherein the computer system is further caused to accept a registration of the geographic mnemonics, and store the geographic mnemonics in one or more storage devices, wherein acceptance of registration and storage of the geographic mnemonics further comprises receipt of the address to be associated with the geographic mnemonics, and storage of the address as associated with the geographic mnemonics

14. The storage medium of claim 13, wherein acceptance of registration and storage of the geographic mnemonics further comprises receipt of meta data to be associated with the geographic mnemonics, and storage of the meta data associated with the geographic mnemonics; and wherein the computer system is further cause to selectively respond to the query about the geographic mnemonics with some or all of the meta data.

15. The storage medium of claim 11, wherein the meta data comprises a direction to the address.

16. The storage medium of claim 11, wherein the address is resolved to a pair of geographic coordinates, and the pair of geographic coordinates is stored as associated with the geographic mnemonics.

17. The storage medium of claim 16, wherein the pair of geographic coordinates comprises a pair of longitudinal and latitude coordinates.

18. The storage medium of claim 16, wherein the computer system is further caused to respond to a query about geographic mnemonics registered at a location or within an area.

19. The storage medium of claim 18, wherein the computer system is further caused to translate the location or area to a pair or a range of geographic coordinates, and search for geographic mnemonics registered fort the location or within the area, based on a result of the translation.

20. The storage medium of claim 11, wherein the query about the geographic mnemonics is received from a client device, via one or more communication interfaces of the computer system; wherein the client device is configured with a browser; wherein the computer system is further caused to support interaction with the browser.

21. The storage medium of claim 11, wherein the query about the geographic mnemonics is received from a selected one of a search engine, a social network or a messaging service; wherein the search engine is configured to allow searches for geographic mnemonics or information associated with geographic mnemonics; wherein the social network includes supports for the geographic mnemonics as users, and supports for other users to be associated with or interact with the geographic mnemonics; wherein the messaging service include supports for geographic mnemonics, and supports for performing message searches based on geographic mnemonics; and wherein the computer system is further caused to support interaction with the search engine, the social network or the messaging service.

22. A computer-implemented method for providing information about a location or area, comprising:
accepting, by a computing system, a registration of a geographic mnemonics, and storing the geographic mnemonics in one or more storage devices of the computer system, wherein accepting registration and storing the geographic mnemonics further comprises receiving an address to be associated with the geographic mnemonics, and storing the address as associated with the geographic mnemonics; and
responding, by the computing system, to a query about the geographic mnemonics, with at least the associated address.

23. The method of claim 21, wherein accepting registration and storing the geographic mnemonics further comprises receiving meta data to be associated with the geographic mnemonics, and storing the meta data as associated with the geographic mnemonics; and responding further comprises selectively responding to the query about the geographic mnemonics with some or all of the meta data.

24. An apparatus for providing information about a location or area, comprising:
one or more processors;
one or more storage devices coupled with the one or more processors;
a search engine configured to be operated by the one or more processors to provide search services to a plurality of client devices, wherein the search services include searches for information associated with geographic mnemonics or geographic mnemonics at a location or within an area; and wherein the search engine is further configured to query a geographic mnemonics service for the information associated with geographic mnemonics, in response to receipt of a search for information associated with a geographic mnemonics or a search for geographic mnemonics at a location or within an area, wherein a geographic mnemonics has associated information.

25. The apparatus of claim 22, wherein the search engine is further configured to provide search services, additionally based on response to the query from the geographic mnemonics service.

26. An apparatus for providing information about a location or area, comprising:
one or more processors;
one or more storage devices coupled with the one or more processors;
a social networking service configured to be operated by the one or more processors to provide social networking to a plurality of client devices, wherein the social networking service includes supports for the geographic mnemonics as users, and supports for other users to be associated with or interact with the geographic mnemonics; and wherein the social networking service is further configured to query a geographic mnemonics service, for an address based on a geographic mnemonics or for geographic mnemonics at a location or within an area, wherein a geographic mnemonics has at least an associated address.

27. The apparatus of claim 22, wherein the social networking service is further configured to provide social networking, additionally based on response to the query from the geographic mnemonics service.

28. An apparatus for providing information about a location or area, comprising:
one or more processors;
one or more storage devices coupled with the one or more processors;
a messaging service configured to be operated by the one or more processors to facilitate messaging by a plurality of client devices, wherein the messaging service includes recognition of geographic mnemonics; and wherein the messaging service is further configured to query a geographic mnemonics service, for information associated with a geographic mnemonics or for geographic mnemonics at a location or within an area, wherein a geographic mnemonics has associated information.

29. The apparatus of claim 22, wherein the messaging service is further configured to facilitate messaging, additionally based on response to the query from the geographic mnemonics service.

30. An apparatus for providing information about a location or area, comprising:
one or more processors;
one or more storage devices coupled with the one or more processors;
an Internet portal service, an e-commerce service, or an email service respectively configured to be operated by the one or more processors to provide Internet portal service, e-commerce service, or email service to a plurality of client devices, wherein the Internet portal service, e-commerce service, or email service includes support of geographic mnemonics; and wherein the Internet portal service, e-commerce service, or email service is further configured to query a geographic mnemonics service, for information associated with a geographic mnemonics or for geographic mnemonics at a location or within an area, wherein a geographic mnemonics has associated information.

31. The apparatus of claim 30, wherein the Internet portal service, an e-commerce service, or an email service is further configured to provide the corresponding Internet portal service, e-commerce service, or email service additionally based on response to the query from the geographic mnemonics service.

32. A computer-implemented method for providing information about a location or area, comprising:
registering with a geographic mnemonics service, using a computer device, a geographic mnemonics, including registering an address to be associated with the geographic mnemonics.

33. The method of claim 32, further comprising registering meta data to be associated with the geographic mnemonics.
